(19) United States
(12) Patent Application Publication
(10) Pub. No.: US 2015/0124150 A1
(43) Pub. Date: May 7, 2015

(54) IMAGING MECHANISM AND FORWARD-MONITORING CAMERA USING SAME IMAGING MECHANISM

(71) Applicant: DENSO CORPORATION, Kariya-city, Aichi-pref. (JP)

(72) Inventor: Katsuhiko Hibino, Anjo-shi (JP)

(21) Appl. No.: 14/397,061

(22) PCT Filed: Mar. 27, 2013
(86) PCT No.: PCT/JP2013/059088

§ 371 Date: Oct. 24, 2014

(30) Foreign Application Priority Data
Apr. 27, 2012 (JP) 2012-103328

(51) Int. Cl. G06K 9/00; H04N 7/18; H04N 5/225

(52) U.S. Cl. CPC G06K 9/00825; H04N 5/2252; H04N 7/18
USPC 348/335

(57) ABSTRACT

An imaging mechanism provided in a forward surveillance camera can adjust, without using a mechanical constitution, light intensity brought into an image sensor by adjusting the light intensity passing through a liquid crystal shutter disposed in an adjusting part. For example, when the light intensity is great during the day, or the like, the resolution of images taken during the day can be improved by the light passing through the adjusting part being shielded and the light intensity brought into the image sensor being reduced. When there is little light intensity at night, or the like, the brightness of images taken at night can be improved by light passing through the adjusting part and the light intensity brought into the image sensor being increased.

### CROSS REFERENCE TO RELATED APPLICATIONS

This application is a U.S. National Phase Application under 35 U.S.C. 371 of International Application No. PCT/JP2013/059088 filed on Mar. 27, 2013 and published in Japanese as WO 201 3/161495 A1 on Oct. 31, 2013. This application is based on and claims the benefit of priority from Japanese Patent Application No. 2012-103328 filed Apr. 27, 2012. The entire disclosures of all of the above applications are incorporated herein by reference.

### BACKGROUND OF THE INVENTION

1. Technical Field

The present invention relates to an imaging mechanism and a forward-monitoring camera using the imaging mechanism.

2. Background Art

Currently, to many vehicles, forward-monitoring cameras which monitor the conditions ahead of the vehicles are provided.

For monitoring with the forward-monitoring camera, in many cases, there is adopted a method where the forward-monitoring camera is mounted to an inner surface of a windshield and monitors the conditions ahead of the vehicle through the windshield.

In this case, the forward-monitoring covers a part of the windshield, and also becomes a factor narrowing the interior space of the vehicle. Accordingly, various efforts have been made for downsizing the forward-monitoring camera (PTL1).

PTL1 Japanese Patent Application Publication No. 2005-112051

### SUMMARY

By the way, since the forward-monitoring camera is needed to monitor the conditions ahead of the vehicle accurately, performance depending on the accuracy is required.

In order to improve the performance, it is considered to provide an aperture mechanism and so on. However, because of the aforementioned demand for downsizing and receiving shake from the vehicle, it is difficult to provide a mechanical configuration such as an aperture mechanism to the forward-monitoring camera.

Accordingly, in order to secure sensitivity during the night-time, the aperture of the lens has to be fixed small. This leads to a problem where the resolution significantly lowers when the conditions ahead of the vehicle is monitored during the day-time.

As the solutions for solving this problem, it is considered to combine many lenses or to use expensive lenses. However, this involves a problem of increasing the price.

The present invention has as its object the provision of an imaging mechanism capable of regulating the light intensity without using a mechanical configuration and a forward-monitoring camera having the imaging mechanism.

In a imaging mechanism according to an aspect of the present invention, a regulation portion is set within a light path extending toward an imaging means through the lens and along the periphery edge of the light path when its cross-section perpendicular to an optical axis of the light path is viewed, the regulation portion has a predetermined width radially extending from the periphery edge toward the optical axis, and a transmitting light intensity regulation member is disposed at the regulation portion, thereby regulating light intensity of light which the regulation portion transmits.

### BRIEF DESCRIPTION OF THE DRAWINGS

In the accompanying drawings:

FIG. 1 is a perspective view of a forward-monitoring camera of an embodiment of the present invention, as viewed from obliquely above;

FIG. 2 shows explanatory views, on a triangular projection basis, of a bracket constituting the forward-monitoring camera of the embodiment with (a) being a plan view, (b) being a right side view and (c) being a bottom view;

FIG. 3 is an exploded perspective view of the forward-monitoring camera of the embodiment;

FIG. 4 is a schematic view of an imaging mechanism which the forward-monitoring camera of the embodiment has;

FIG. 5 is a perspective view showing a forward-monitoring camera body of the embodiment with a hood;

FIG. 6 is a flowchart of an aperture control;

FIG. 7 is a chart showing light intensity at each position along a radial direction from an optical axis as a center portion with (a) being a chart when an aperture is not narrowed, (b) being a chart when the aperture is narrowed;

FIG. 8 is a chart showing resolution at each position along a radial direction from an optical axis as a center portion with (a) being a chart when an aperture is not narrowed, (b) being a chart when the aperture is narrowed;

FIG. 9 is a schematic view showing another imaging mechanism as a modification;

FIG. 10 is a side view schematically showing the vehicle where the forward-monitoring camera of the embodiment is mounted.

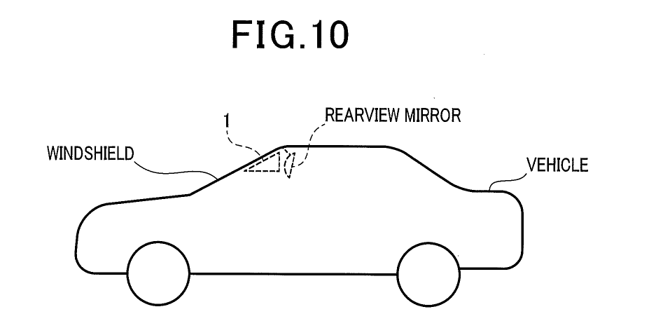

### DETAILED DESCRIPTION OF THE PREFERRED EMBODIMENTS

With reference to the drawings, hereinafter is described an embodiment of the present invention.

A forward-monitoring camera of the present invention is used for imaging the conditions ahead of the vehicle. In the following description, a forward direction is defined to be a direction to which the forward-monitoring camera is directed in a state where the forward-monitoring camera is correctly mounted to the windshield of the vehicle at a predetermined position thereon to image the conditions ahead of the vehicle.

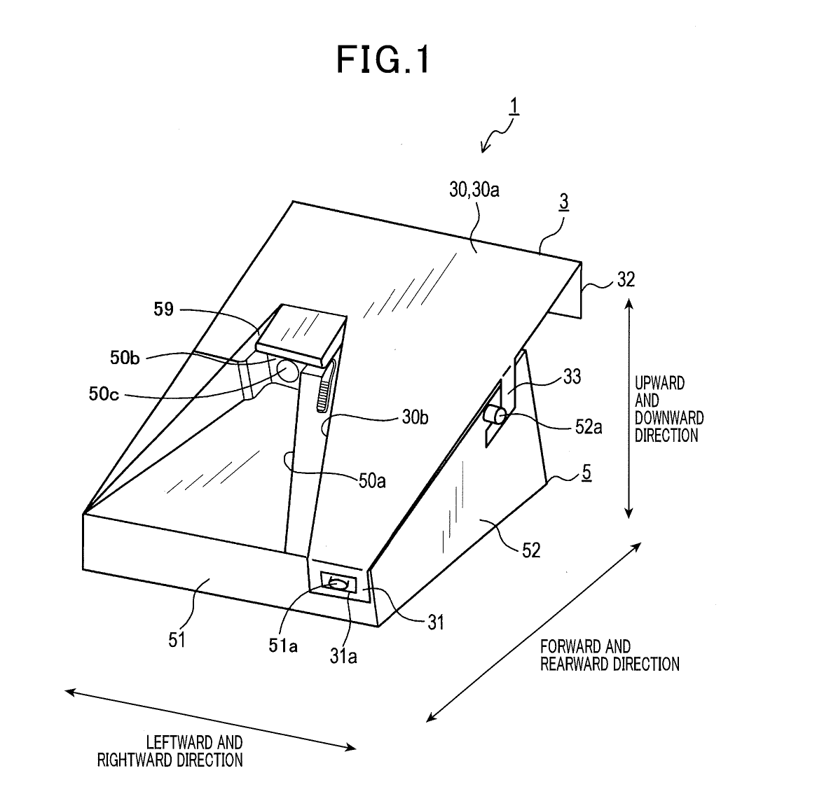

Further, the terms rearward, rightward, leftward, upward and downward used in the following description are the directions based on triangular projection with the forward direction relative to the vehicle being a front, and thus the description referring such as to plan views or rear views is also based on triangular projection (see FIG. 1).

### General Structure

As shown in FIG. 1, an forward-monitoring camera 1 of the present embodiment includes a bracket 3 that is attached and fixed onto a windshield from inside the vehicle, and an forward-monitoring camera body 5 that has a housing in which an imaging device and the like are accommodated.

### Bracket

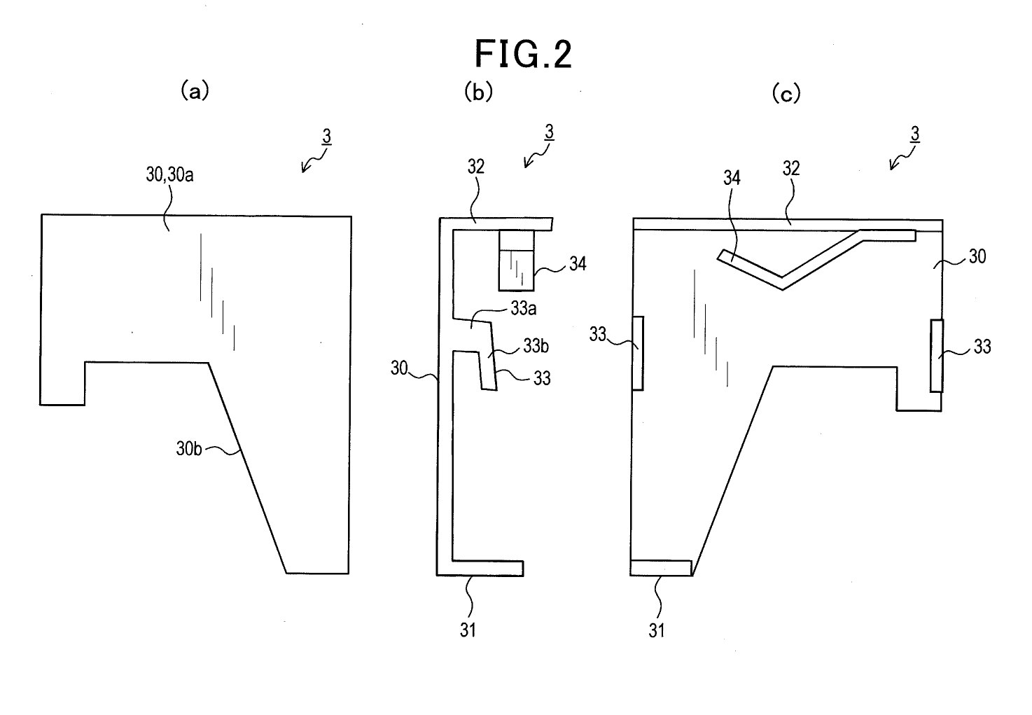

As shown in FIG. 1 and FIG. 2 by (a), the bracket 3 includes an attachment portion 30 that is attached to a windshield.

An attachment surface 30a of the attachment portion 30 is attached to a windshield. The attachment surface 30a is formed into a flat shape so as to extend along the glass surface in a portion of a windshield, to which the bracket 3 is attached.

In the attachment portion 30, a cut-out portion 30b is formed. The cut-out portion 30b is formed by cutting off a portion by an area slightly larger than the recess 50a. The portion that is cut off includes a portion that is opposed to a recess 50a, described later, when the forward-monitoring camera body 5 is mounted to the bracket 3.

The bracket 3 includes a front end portion 31 and a rear end portion 32. The front end portion 31 is a portion bent downward from a front end of the attachment portion 30 on the right of the cut-out portion 30b, i.e. a portion extended downward from the front end of the attachment portion 30. The rear end portion 32 is a portion bent downward from a rear end of the attachment portion 30, i.e. a portion extended downward from the rear end of the attachment portion 30.

The front end portion 31 is provided with an engagement hole 31a into which an engagement projection 51a, described later, provided to a front side surface of the forward-monitoring camera body 5 is inserted and fitted.

As shown in FIG. 1 and FIG. 2 by (b) and (c), the bracket 3 includes a pair of hook portions 33 which are arranged on right and left ends of the bracket 3. Specifically, the hook portions 33 are each bent from the right or left side of the attachment portion 30 so as to be perpendicular thereto, and each have a hooked end extended forward along the attachment surface 30a. The pair of hook portions 33 are positioned slightly rearward relative to the center in a longitudinal direction.

The hook portions 33 each include a base 33a and a hook 33b. The base 33a is projected downward from the attachment portion 30. The hook 33b is extended forward along the attachment surface 30a from a lower end of the base 33a and has a length larger than that of the engagement projection 51a, described later.

The rear end portion 32 has an inner surface (front side face) which is provided with the leaf spring 34.

### Forward-monitoring Camera Body

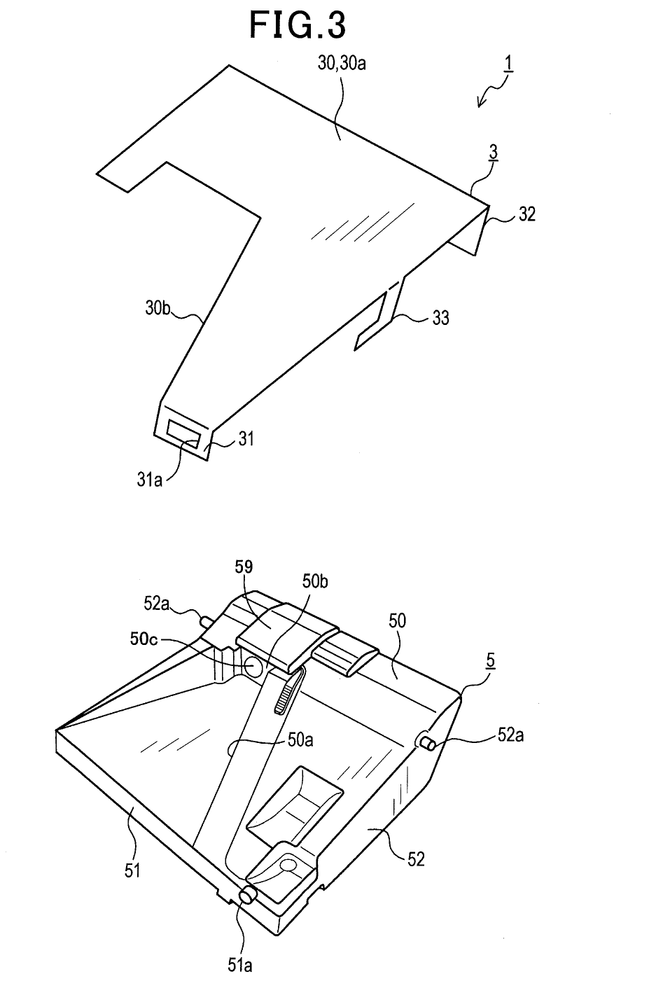

As shown in FIG. 3, the forward-monitoring camera body 5 is formed into substantially a box-like shape with an upper surface 50 that is inclined upward in a direction from the front toward the rear.

The upper surface 50 of the forward-monitoring camera body 5, in a plan view, has the recess 50a in a trapezoidal shape with an end on the front left being a lower base and with a right-left width narrowing toward the rear.

The recess 50a is a portion for preventing the field of view of the forward-monitoring camera body 5 from being blocked during imaging the conditions ahead of the vehicle through the windshield.

The recess 50a is formed so as to be deeper toward the rear.

A projection portion 59 is provided adjacent to the rear end of the recess 50a and on the upper surface 50 of the forward-monitoring camera body 50.

The projection portion 59 is formed to projects from the upper surface 50 upward.

In this embodiment, the forward-monitoring camera body 5 is mounted to the bracket 3 in a state where the upper surface 50 of the forward-monitoring camera body 5 contacts a lower surface of the bracket 3. The projection portion 59 is formed to have a height where the thickness of the bracket 3 is put on the upper surface 50 such that the upper end of the projection portion 59 contacts the windshield through the cut-out portion 30b when the forward-monitoring camera body 5 is mounted to the bracket 3.

By providing the recess 50a and the projection portion 59, a wall surface 50b is formed at the upper base of the recess 50a, and a lens 50c for the camera is provided at an upper portion of the wall surface 50b.

### Imaging Mechanism

Next is described an imaging mechanism provided inside the aforementioned forward-monitoring camera body 5.

The imaging mechanism 7 has the aforementioned lens 50c, an image sensor 70, a lens 71 disposed between the lens 50c and the image sensor 70, a liquid crystal shutter 73 and a control device 72. The control device 72 has a computer, is electrically connected to the liquid crystal shutter 73 and the image sensor 70, and performs an aperture control described later. Further, the control device 72 obtains an image signal from the image sensor 70 and performs predetermined image processes for recording or executing driving support.

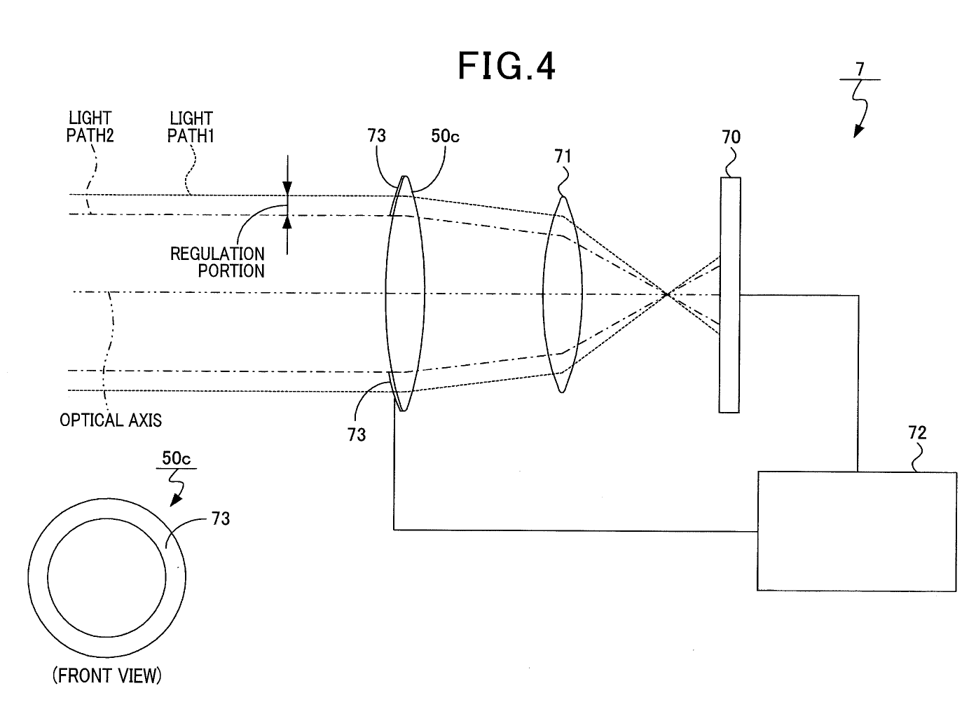

The liquid crystal shutter 73 is layered on the front surface of the lens 50c along the outer periphery edge. The liquid crystal shutter 73 is formed to have a ring-like shape, as shown in the front view of FIG. 4.

The liquid crystal shutter 73 can switch between a transmissive state permeable to light and a non-transmissive state which is not permeable to light. The control for switching between the transmissive state and the non-transmissive state is performed by the aperture control executed in the control device 72, described later. In this embodiment, the liquid crystal shutter 73 is formed as a flexible liquid crystal film which can be layered fitting the curve of surface of the lens 50c. The liquid crystal film has, for example, transparent and flexible substrates (polycarbonate, etc.), a liquid crystal enclosed between the substrates (polymer dispersion type crystal liquid, etc.), and transparent electrodes for an orientational control of the crystal liquid.

The crystal liquid shutter 73 is formed to have a size to be disposed at least at a regulation portion. The regulation portion is within a light path 1 extending toward the image sensor 70 through the lens 50c and the lens 50c, along the periphery edge of the light path 1 when its cross-section perpendicular to the optical axis of the light path 1 is viewed, and has a predetermined width radially extending from the periphery edge toward the optical axis. The width of the regulation portion is set to each forward-monitoring camera, depending on a performance of the image sensor 70 or the lens 50c and the like.

In this embodiment, a CMOS sensor is used as the image sensor 70, however, it should be noted that the image sensor 70 is not limited to this.

### Regarding Mounting Process

Hereinafter is described a process of mounting the forward-monitoring camera 1 configured as described above to a windshield of a vehicle in the course of manufacturing the vehicle.

The forward-monitoring camera 1 of this embodiment is used for imaging the conditions ahead of the vehicle and correctly detecting the positions of lane markers as viewed from the position of the camera and the presence/absence, for example, of lighting of the head lights of oncoming vehicles. Accordingly, the forward-monitoring camera 1 is required to be correctly attached to the windshield.

Therefore, the bracket 3 is correctly attached in advance to a position that enables the detection mentioned above, at a stage where a windshield has been fabricated but is yet to be put on a vehicle assembly line.

The bracket 3 is attached to the windshield by applying an adhesive to the attachment surface 30a of the bracket 3 and sticking the surface onto the windshield.

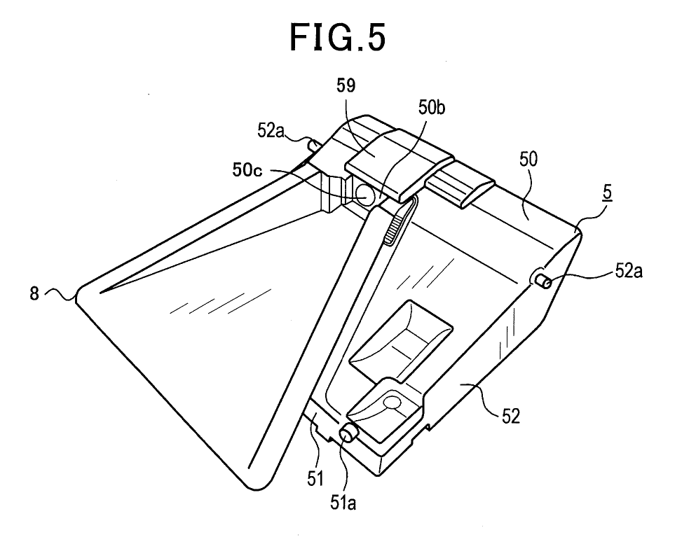

As shown in FIG. 5, a hood 8 is mounted to the recess 50a of the forward-monitoring camera body 5. The hood 8 is a means for blocking the light toward the lens 50c from directions except for the forward direction of the vehicle, in order to prevent so-called background reflections. The background reflections cause images except for the conditions ahead of the vehicle to be captured, because the light from the directions except for the forward direction of the vehicle is reflected on the windshield thereby being directed toward the lens 50c.

The forward-monitoring camera body 5 with the hood 8 is mounted to the bracket 3.

In the work of mounting the forward-monitoring camera body 5 to the bracket 3 (see FIGS. 1 to 3), at first, the bosses 52a are firstly hooked on the respective hook portions 33, while they are slid obliquely upward in the rear from below along the glass surface of the windshield.

With the sliding, the rear surface of the forward-monitoring camera body 5 is eventually brought into contact with the leaf spring 34, first, to push and elastically deform the leaf spring 34.

In this embodiment, the bosses 52a are each provided to a position that makes shorter a distance from the front end of the engagement projection 51a to the boss 52a than a distance from the base 33a of the corresponding hook portion 33 to the front end portion 31 in view from the front tip end of the engagement projection 51a. Therefore, upon contact of each of the bosses 52a with the base 33a of the corresponding one of the hook portions 33, the forward-monitoring camera body 5 can be placed relative to the bracket 3 such that the engagement projection 51a is inserted and fitted into the engagement hole 31a.

When the worker's hands that have supported the forward-monitoring camera body 5 for the above work are removed after the placement, the forward-monitoring camera body 5 is slightly returned back forward by the leaf spring 34, and along with this movement, the engagement projection 51a is inserted and fitted into the engagement hole 31a. In this case, the bosses 52a do not come off from the respective hook portions 33 because the hook 33b of each of the hook portions 33 is formed so as to have a larger length than the that of the engagement projection 51a.

In this way, the forward-monitoring camera body 5 is urged by the leaf spring 34 for the insertion of the engagement projection 51a into the engagement hole 31a, while being brought into contact with the front end portion 31. Further, the upper surface 50 of the in-vehicle camera body 5 is also brought into contact with a rear surface of the attachment portion 30 (surface opposed to the forward-monitoring camera body 5) so as to press the forward-monitoring camera body 5 against the bracket 3 for fixation.

### Aperture Control

Next is described the aperture control performed in the control device 72 configuring the imaging mechanism 7 (see FIG. 4).

The aperture control is a control which is always performed while the forward-monitoring camera 1 monitors the conditions ahead of the vehicle, and is repeatedly performed at a given interval in this embodiment.

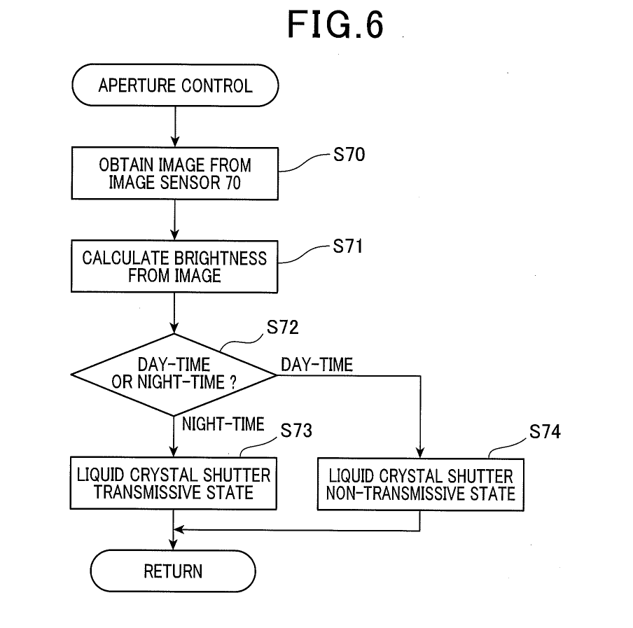

When the aperture control starts, as shown in FIG. 6, at first, a process of S70 is carried out. In this S70, a process where the image data of the captured image are obtained from the image sensor 70 (see FIG. 4) is carried out.

Next, in S71, the control device 72 performs, on the basis of the image data of the captured image which has been obtained in S70, a process where the brightness of the image is calculated.

In the calculation of the brightness, the average of the brightness may be calculated from data on the brightness of all pixels configuring the image sensor 70, or the average of the brightness may be calculated from data on the brightness of pixels at arbitrary points (for example, arbitrary pixels are chosen at a given interval from the center of the image to the edge of the image). The calculation method is arbitrary.

Thereafter, in S72, a process where it is determined whether it is during the day-time or the night-time is carried out on the basis of the brightness calculated in S71.

After that, if, in the determination (S72), the control device 72 determines that it is during the night-time (the brightness of the image is dark, or the light intensity is small) (S72: NIGHT-TIME), a control is executed (S73). In the control (S73), the control device 72 makes the liquid crystal shutter 73 transmissive, that is, passes the light through the regulation portion to increase the light intensity captured by the image sensor 70. On the other hand, if the control device 72 determines that it is during the day-time (the brightness of the image is brighter than that during the night-time, or the light intensity is large) (S72: DAY-TIME), a control is executed (S74). In the control (S74), the control device 72 makes the liquid crystal shutter 73 non-transmissive, that is, executes the aperture control for blocking the light from passing through the regulation portion to decrease the light intensity captured by the image sensor 70.

That is, when the S73 and S74 are executed, as shown in FIG. 4, the liquid crystal shutter 73 is opened during the night-time, and the light is captured through the maximum range (light path 1). On the other hand, when the liquid crystal shutter 73 is closed, the circumferential edge of the lens 50c is closed, thereby the light is captured through a range narrower by the closed portion (light path 2).

Here are described effects of performing the aperture control during the day-time.

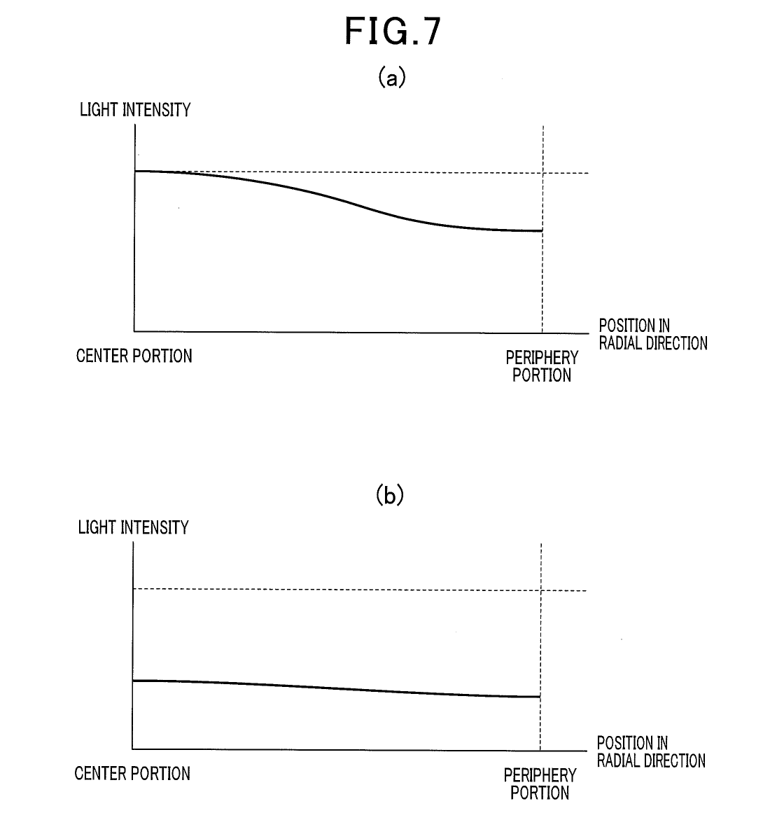

As shown in FIG. 7, comparing the state where the liquid crystal shutter 73 is opened ((a) of FIG. 7) with the state where the liquid crystal shutter 73 is closed ((b) of FIG. 7), the light intensity entering into the image sensor 70 in the state where the liquid crystal shutter 73 is opened ((a) of FIG. 7) is larger in the whole radial direction.

However, if the liquid crystal shutter 73 is closed to narrow it down ((b) of FIG. 7), the light intensity ranges substantially uniformly from the center of the image to the edge of the image, compared with when the liquid crystal shutter is opened ((a) of FIG. 7).

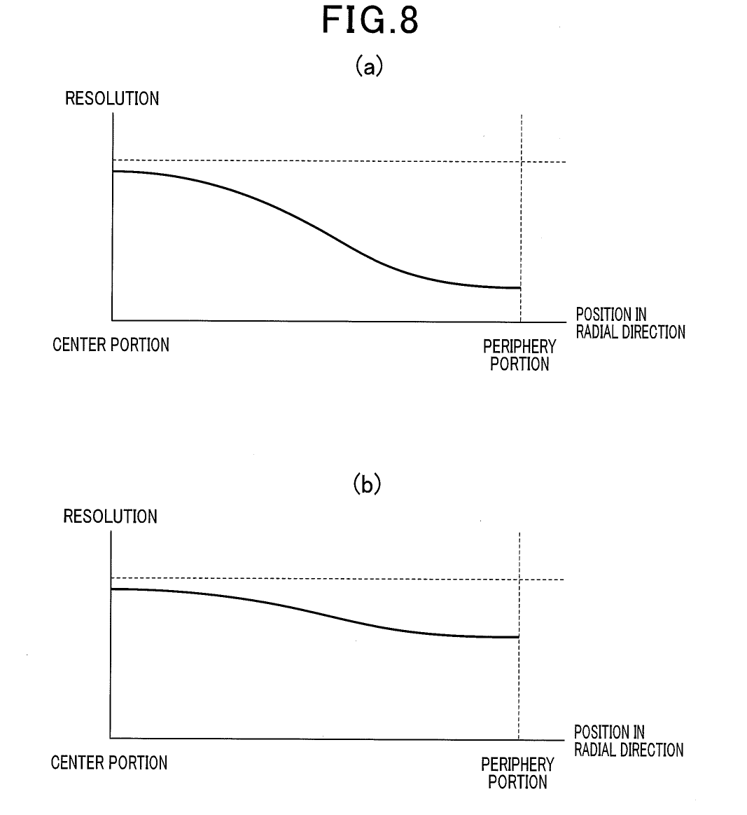

Further, as shown in FIG. 8, when the liquid crystal shutter 73 is closed ((b) of FIG. 8), the resolution of the whole image increases, compared with when the liquid crystal shutter 73 is opened ((a) of FIG. 8).

Thus, during the day-time, closing the liquid crystal shutter 73 by the aforementioned aperture control enables the uniformity of the light intensity of the whole picture plane, and can increase the resolution of the image.

On the other hand, during the night-time, the light intensity of the light captured by the image sensor 70 through the lens 50c is small. Accordingly, opening the liquid crystal shutter 73 to capture more light into the image sensor 70 causes the resolution of the image to lower ((a) of FIG. 8), but makes the image bright ((a) of FIG. 7), which can increases minimum sensitivity.

During the night-time, only a range where the headlight lights is imaged. Because of such a limitation, the resolution only has to be secured at a level where parting lines of lanes at the vicinity of the vehicle can be recognized. Instead light intensity needed for imaging is insufficient. Accordingly, in the above aperture control, the liquid crystal shutter 73 is opened to capture most possible light in the image sensor 70.

The above-described configuration can achieve both securement of sensitivity during the night-time and good resolution during the day-time in spite of at a low price.

Characteristic Functions and Effects of this Embodiment, etc.

Now is described characteristic functions and effects of the aforementioned forward-monitoring camera 1 in this embodiment.

In the forward-monitoring camera 1 of this embodiment, the light intensity captured in the image sensor 70 can be regulated, without using a mechanical configuration, by regulating the light intensity (further specifically, the light intensity of transmitted light per unit of area of the transmitting light intensity regulation member) passing the liquid crystal shutter 73 disposed at the regulation portion.

For example, when the light intensity is large such as during the day-time, the light passing the regulation portion is blocked to use the center portion of the lens 50c. This can increase the resolution of the image captured during the day-time. On the other hand, when the light intensity is small such as during the night-time, the regulation portion transmits the light thereby increasing the light intensity captured in the image sensor 70. This can also increase the brightness of the image captured during the night-time. That is, the minimum sensitivity can be increased.

It can achieve both securement of sensitivity during the night-time and good resolution during the day-time in spite of at a low price. In the forward-monitoring camera 1 of this embodiment, the light except for the regulation portion can be taken in directly by the image sensor 70 through the lenses 50c and 71. This enables high-performance imaging by using the minimum number of lenses 50c, 70 and by using the image sensor 70 having basic performance.

### Correspondence Relation

The image sensor 70 of this embodiment corresponds to the imaging means of the present invention, hereinafter similarly, the liquid crystal shutter 73 corresponds to the transmitted light intensity regulation member, and the control device 72 corresponds to the transparency control means.

### Other Modifications

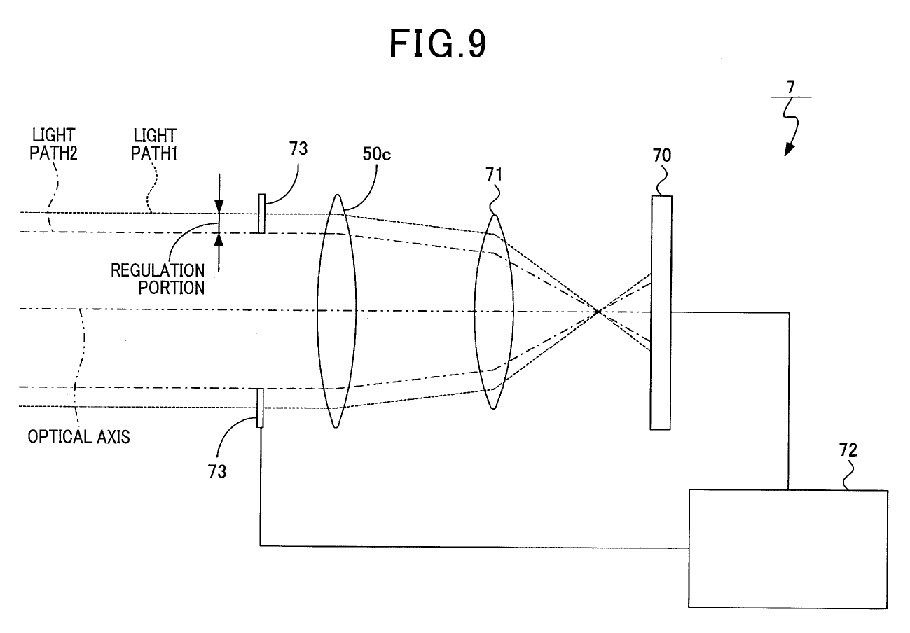

In the above embodiment, an example where the liquid crystal shutter 73 is layered on the lens 50c is described. Alternatively, the liquid crystal shutter 73 may be provided separately from the lens 50c. In this case, for example, as shown in FIG. 9, the liquid crystal shutter 73 may be provided ahead of the lens 50c.

In the above embodiment, an example where the liquid crystal shutter 73 is layered on the lens 50c and the transparency of the liquid crystal shutter 73 is controlled is described. Alternatively, in place of the liquid crystal shutter 73, there may be layered a film made from a photochromic material whose transparency changes depending on light intensity (the transparency lowers when it is bright, and the transparency increases when it is dark).

As the photochromic materials, there can be used materials containing an ultraviolet color-change substance which chemically changes by ultraviolet light. As the ultraviolet color-change substances, there may be used an organic photochromic material such as a spiropyran-based compound, a dihydroindolizine-based compound, a fulgide-based compound, a tetrobenzoperopyrene derivative, a dihydripyrene-based compound, a thioindigo-based compound, a acenophane derivative, a viologen or a diphenylthiocarbazone metal compound. There may be used an inorganic photochromic material such as a silver halide.

It should be noted that application of the present invention is not limited to the forward-monitoring camera of the above embodiments. For example, the forward-monitoring camera of the above embodiment is attached to the upper portion of the windshield and behind the rear view mirror. However, it may be attached to the lower portion of the windshield. Alternatively, the imaging mechanism of the present invention may be used in a monitoring camera which is attached to a part of the vehicle except for the windshield or a monitoring camera used for other than the vehicle. However, it is preferred that using in the forward-monitoring camera monitoring the conditions ahead of the vehicle where it is difficult to provide a mechanical configuration because of receiving shake from the vehicle.

It should be noted that the present invention may be a configuration accords with the spirit of the invention described in the claims, and is not limited to the above embodiments.

### REFERENCE SIGNS LIST

1 . . . forward-monitoring camera, 2 . . . light path, 3 . . . bracket
5 . . . forward-monitoring camera body, 7 . . . imaging mechanism, 8 . . . hood
30 . . . attachment portion, 30a . . . attachment surface, 30b . . . cut-out portion
31 . . . front end portion, 31a . . . , 32 . . . rear end portion
33 . . . hook portion, 33a . . . base, 33b . . . hook
34 . . . leaf spring, 50 . . . upper surface, 50b . . . wall surface
50c . . . lens, 51a . . . engagement projection, 52a . . . boss
59 . . . projection portion, 70 . . . image sensor, 71 . . . lens
72 . . . control device, 73 . . . liquid crystal shutter

What is claimed is:

1. A forward-monitoring camera that monitors conditions ahead of a vehicle, comprising:
a lens;
an imaging means for imaging the conditions ahead of the vehicle through the lens;
a camera body that accommodates the imaging means, the camera body being mounted to a bracket fixed to a windshield of the vehicle;
a control device that processes image data obtained from the imaging means to recognize at least a lighting of a head light of an oncoming vehicle and a lane marker; and
a transmitting light intensity regulation member regulating light intensity of light which a regulation portion transmits, the regulation portion being set within a light path extending toward the imaging means through the lens and along the edge of the light path when its cross-section perpendicular to an optical axis of the light path is viewed, the regulation portion having a predetermined width radially extending from the edge toward the optical axis.

2. The forward-monitoring camera according to claim 1, wherein
the transmitted light intensity regulation member is disposed at the regulation portion, and has a capacity to change its transparency.

3. The forward-monitoring camera according to claim 1, wherein
the transmitted light intensity regulation member is made from liquid crystal, and has a transparency control means for controlling the transparency of the liquid crystal.

4. The forward-monitoring camera according to claim 1, wherein
the transmitted light intensity regulation member is made from a photochromic material whose transparency lowers as the light intensity into the regulation portion increases.

5. The forward-monitoring camera according to claim 1, wherein
the transmitted light intensity regulation member is layered on the lens.

6. (canceled)
